(19) United States
(12) Patent Application Publication
(10) Pub. No.: US 2005/0071186 A1
(43) Pub. Date: Mar. 31, 2005

(54) Integrated trade event activity and information system

(76) Inventor: Richard G. Manzo, San Diego, CA (US)

Correspondence Address: NATH & ASSOCIATES, PLLC, Sixth Floor, 1030 15th Street, N.W., Washington, DC, 20005, US

(21) Appl. No.: 10/951,904

(22) Filed: Sep. 29, 2004

Related U.S. Application Data
(60) Provisional application No. 60/506,976, filed on Sep. 29, 2003.

(51) Int. Cl. G06F 17/60

(52) U.S. Cl. 705/1

(57) ABSTRACT

In a method, system and machine readable medium, customer information, sales offering information, and ordering information are integrated to maximize utility to both buyers and sellers at a trade event presented by a client. Activity sheets for each of a number of exhibitors based on the selections of products that the client will carry for each exhibitor are created. The activity sheets are accessible from a database through a server employed at the trade event. An exhibitor point-of-sale (POS) terminal, e.g. a touchscreen, accesses the exhibitor's activity sheet from the server. Customer selections are registered in a database in the server. At additional terminals, the customer order can be accessed by the customer or sales representatives for further service. Sales information is available in real time for marketing use during the event. After the event, reports are readily available to the exhibitors.

### CROSS REFERENCES TO RELATED APPLICATIONS

This patent application claims priority to U.S. Provisional Patent Application Ser. No. 60/506,976, filed Sep. 29, 2003, the disclosure of which is incorporated herein by reference in its entirety.

### FIELD OF THE INVENTION

The present subject matter relates to a method, system, and machine readable medium for collecting and acting on customer information, sales offering information, and customer order selections at a tradeshow or other product events and for deriving further useful information therefrom for selective provision to both buyers and sellers.

### BACKGROUND OF THE INVENTION

Trade events and trade shows are common happenings which permit customer viewing and/or purchasing of selected products. A significant type of such trade events or trade shows is referred to as an ordering show. At these ordering shows, goods or services are promoted, and special allowances or discounts are given on selected items. The show is typically sponsored by an organization referred to as a client. The client in many instances will be a wholesaler or an association. Many wholesalers hold one or more shows a year. Exhibitors at the show commonly comprise suppliers of the client who offer goods or services at the show. Suppliers may be manufacturers, brokers, specialty companies and other organizations who sell through clients. The event is attended by customers of the client such as retail stores, restaurants, institutions and other buyers.

During the course of the year, customers generally place wholesale orders with the client. The ordering show is a special occasion at which customers interact with exhibitor representatives. In addition to promoting goods, ordering shows may also be used to promote services or entertainment media or other intangible items. The ordering show activity could comprise customer education or advertising in addition to or in the alternative to sale of goods or services.

Commonly, an exhibitor will have its own booth at an ordering show to promote sales of the exhibitor's goods through the client. Owners, franchisees or representatives of customer organizations attend the ordering show and place orders with exhibitors. Accordingly, the exhibitors use the ordering show as an opportunity to promote their marketing programs and to promote particular goods. Special discounts, often referred to as allowances, are provided at times to increase the sale of goods. Exhibitors may further use point programs, often called show points, to create incentives for customers to buy their goods. Other incentives may also be provided.

A single nominal trade show may have 50 to 500 exhibitors participating. A nominal exhibitor may offer between one and several hundred items. The trade show may be attended by hundreds or even thousands of customers. In the course of organizing, executing and following up on a trade show, many different forms of data are produced that need to be entered into a record keeping system, correlated, stored and acted upon.

One such form of data is registration information. This data identifies attendees of the trade show and can specify where their orders are to be shipped and also confirm an individual attendee's authority to place orders. Another form of data is sales offering information, commonly including product identification, product description, size or number of components per unit order, pricing information, promotional discounts, and quantity discounts. The customer's input in response to the sales offering information will include ordering information, often in terms of quantity. This ordering information must be collated so orders may be fulfilled. The client and exhibitor also want to collect information that will enable them to obtain metrics to indicate the usefulness of particular incentives. Further information processing useful in marketing research may also be done.

Some degree of automation has been provided to assist in the collection and utilization of information at trade shows. In this regard, U.S. Pat. No. 4,654,793 discloses a system in which a bar-coded identification is given to a trade show attendee and in which codes may be provided indicating activities to which the attendee is entitled to admission. After the trade show is over, information collected on the attendee is processed to provide selective compilations about the activities of attendees. Likewise, U.S. Pat. No. 6,513,710 discloses a system producing registration information and lead collection. A bar coded identity badge is provided to identify a customer.

A number of automated functions have also previously been provided for use with respect to individual electronic commerce transactions. For example, U.S. Pat. No. 6,684,195 discloses a system which maintains an individual customer's purchasing history in a computer and which can issue incentive coupons to a customer. Similarly, U.S. Pat. No. 6,505,168 discloses a system and method for gathering and standardizing customer purchase information for target marketing.

While some automated capabilities have been provided in the past, there have been many shortcomings in the effectiveness of use of data produced at trade shows. Even with the use of the prior art techniques described above, trade shows have by and large continued to use multi-part paper order forms for order entry and fulfillment. In order to use sales data entered on these forms, they must be read, and data collected must be entered into a database. Accordingly, there is a time lag between the activity by the customer and the time at which information is available for use by the exhibitor. While an order entry clerk may key information into a database, or the process may be expedited by use of machine-readable forms, the paper must be handled and processed resulting in the time lag.

Further, in prior art systems multi-part paper order forms must be printed and must be made available at each ordering location. Due to the high number of products and manufacturers, even assuming a very low error rate, a number of errors will inevitably be present in activity forms. Typographical errors cannot be corrected except by reprinting. Suppliers have to issue errata sheets or post conspicuous notices at their booths in an attempt to inform customers.

Accordingly, data is not available in real-time for use by the client, the exhibitors, or the customers. In fact, data is generally not gathered and tabulated until after the show is over, or in the case of a multi-day show, until at least a current day is over. Consequently, suppliers and clients cannot use this information while customers are still present at the show and accessible for further marketing efforts directed at them. Rather, they must tally their own sales records. The result of this is that exhibitors lose the opportunity to further promote products to customers. Further, customers lose the opportunity to take advantage of incentives or other deals that may be made available to them.

Accordingly, there is a need in the art for an easy to use, reliable system for collecting customer purchasing data at a trade show and making this data readily available for use by clients, exhibitors, and/or the customers. The present subject matter addresses this need.

### SUMMARY OF THE INVENTION

Briefly stated, in accordance with the subject matter expressed herein, systems and methods are provided for handling information collected at tradeshows, for example in a paperless manner. One such system comprises a server comprising a product information database containing entries indicative of preselected product offerings available for selection for a customer and made by or on behalf of the customer. Each product offering is associated with an exhibitor. An exhibitor terminal provides access to product offerings from the product information database associated with the respective exhibitor, and a customer purchase database stores selections made for a customer. Selections made for each customer are sortable by exhibitor. A registration database is provided for identifying a customer in response to a customer input. At an exhibitor terminal, order entry means are enabled by an exhibitor and/or customer input. The order entry means operate to register selections made on behalf of the customer and to store data indicative of selections made for the customer in the sales database in association with the customer identification.

In a further form, the present subject matter relates to a machine readable medium providing instructions which, when executed by a processor, cause the processor to perform operations that include establishing an activity form register indicative of groups of product or other offerings. Each product offering comprises a product description and pricing information, and each group is associated with an exhibitor. Access to a group is provided at an exhibitor terminal to enable offering of the group to a customer in response to a customer's having logged in at the terminal. A sales database is established to store sales selections for a customer in association with each exhibitor and to provide to exhibitors ordering data associated with each respective exhibitor and/or customer from the sales register.

### BRIEF DESCRIPTION OF THE DRAWINGS

The present subject matter may be further understood by reference to the following description taken in connection with the following drawings:

FIG. 1 is a block diagram of a system constructed in accordance with the present subject matter and performing the methods of the present subject matter;

FIG. 2 is a block diagram of a master server;

FIG. 3 is an illustration of an activity form;

FIG. 4 is a flow diagram illustrating a process for creation of an activity form;

FIG. 5 is an illustration of a card badge produced in conjunction with show registration;

FIG. 6 is a flow diagram illustrating generation of a advance booking order;

FIG. 7 is a flow diagram illustrating show registration;

FIG. 8 is a block diagram of a point of sale station;

FIG. 9, consisting of FIGS. 9a-9d, illustrates a series of screens presented by a Point of Sale (POS) terminal during a buying transaction;

FIG. 10 is a flow diagram illustrating a method performed by the system with respect to ordering;

FIG. 11 is a screenshot produced by a utility available to POS terminals or sales representative terminals;

FIG. 12 consists of FIGS. 12a and 12b, which are block diagrams respectively of a sales representative station and a customer station;

FIG. 13 is a flow diagram illustrating use of the system by a sales representative;

FIG. 14 is a flow diagram illustrating customer access to sales information; and

FIG. 15 is a flow diagram illustrating production of show information.

### DETAILED DESCRIPTION

Definitions of certain terms as used herein:
“”client refers to the sponsor of a tradeshow;
“products” can refer to physical products, services or information.
“pricing information” can refer to price, allowance, discount and/or another parameter comprising all or part of the components of a price;
“for a customer” refers to an action that can be taken with respect to a customer account or a customer by a customer or by another person, e.g., a sales representative, on behalf of the customer; and
“capture” refers to obtaining or producing information indicative of a parameter.

What is provided herein is a system providing numerous benefits to exhibitors, clients and customers of a trade show. For example, exhibitors can review and correct activity forms before the show. Similarly, problems in software can be identified and fixed before the show, avoiding expensive, inconvenient and error-prone systems for dealing with errata sheets for paper activity forms and show books. The exhibitors can also email reports to their offices from the show floor and provide faster turnaround time to the client for show orders. A paperless tradeshow may be provided.

Likewise, the POS terminals used herein allow for a neat and orderly arrangement of the booths at the trade show. Since the POS terminals operate off of a central server, they do not require programming. In the event of failure, a POS terminal may be quickly replaced with another unit. This allows the exhibitor to review all completed activity forms on one terminal. It is not necessary to leaf through stacks of paper to review sales information which is time consuming, full of delays, and inefficient.

The present system further permits a client to track tradeshow success, in terms of sales and customer reaction, in real-time. Sales representatives are empowered with information as to who is selling, who is ordering and who is not. Since ordering information is collated in real time as orders are entered, difficulty and delay in generating ordering information after the show is eliminated. Faster turnaround time for the exhibitor shows sales is facilitated. A centralized, redundant database of all show data allows for both security and reliability. Thin-client web-based architecture permits easy scalability and high availability. The requirement for proper registration is self-enforcing. Reliable attendance numbers are generated.

Additionally, since sales representatives can communicate with each other, the tradeshow can function as a sales meeting as well. The client is afforded the opportunity of creating an additional profit center by renting additional terminals and by selling ad space on the display. The customer obtains the benefit of maintaining a clear picture of what is being ordered the even after visiting many exhibitors, making it convenient for a customer to return to a particular exhibitor and add to an order. A customer can print a purchase report when leaving the show and review it later. Alternatively, the customer may email a report from the tradeshow. The customer does not have to keep track of a great amount of paper or receipts while at the trade show, which is a significant benefit. Similarly, all of the participants can function without the use of pens. In the course of a nominal show, the use of thousands of sheets of paper can be avoided. Physical waste is likewise eliminated. The large number of technology features utilized in the present purchasing process make it easy and fun for a customer to place orders, further facilitating additional sales.

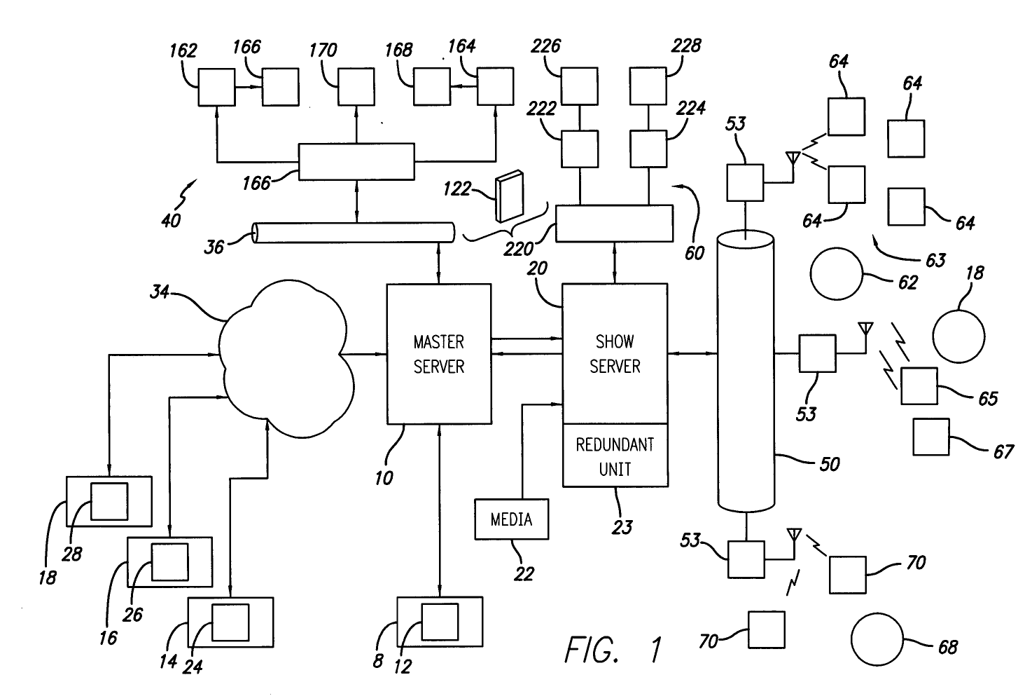

The present subject matter may be particularly described by reference to the figures presented herein. In this regard, FIG. 1 is a block diagram illustrating a system 1 and utilizing methods and programmed media as described herein. A generalized overview of the system 1 and its operation are provided. Further details of each subsystem are further described below. The system 1 utilizes a master server 10. The designation “server” for the server 10 or for other servers described below is arbitrary but is used in the present description to describe an apparatus capable of storing information for use by other terminals and of communicating over communication links. Each server may comprise an apparatus formally designated as a server by its manufacturer. Each server can also or alternatively comprise one or more desktop or laptop computers or other data processing means.

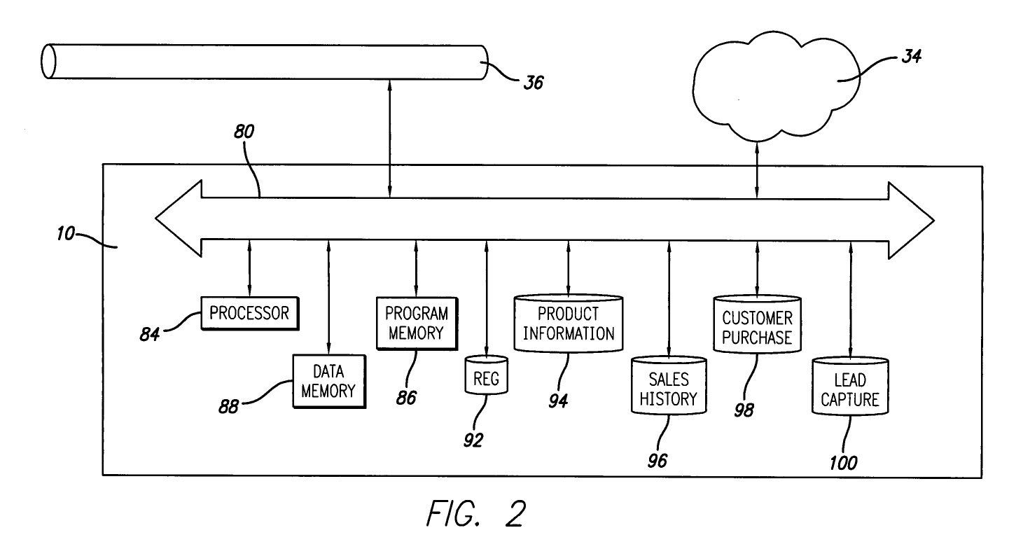

In a preferred form, the present subject matter will be implemented by a company 8 that produces trade shows such as ordering shows, maintains the server 10, and provides its services to clients. However, the server 10 need not be owned by any particular party. The company 8 may interact with the server 10 through a workstation 12. The server 10 includes subsystems and components further illustrated with respect to FIG. 2 below. In a preferred form, the company 8 will work with a client 14 who carries products or otherwise promotes services or information of a plurality of exhibitors 16. Commonly, an ordering show will be carried out on behalf of a single client 14, although this is not a necessity. The company 8, client 14 and exhibitors 16 are illustrated in FIG. 1 as locations of particular apparatus. However, the particular apparatus may be located virtually anywhere. Orders for goods, services and or information are solicited from customers 18. Customers 18 are illustrated as individual units.

A significant application of the preferred embodiments presented herein is at tradeshows which are customarily conducted by clients one or more times a year and at which the primary trade activity is selling. At the tradeshows, exhibitors 16 who deal through a particular client 14 showcase their wares and offer special discounts and incentives customarily not otherwise available to customers. The exhibitors 16 are generally manufacturers, brokers or companies that are intermediaries between producers and clients. A manufacturer that is too small to have its own representation with a major client may deal through a broker or other company, who will act as an exhibitor 16. The customers 18 generally comprise persons who purchase at wholesale and sell at retail. The customers 18 may be store owners, franchisees, operators or managers of particular chain units, or other wholesale buyers, for example restaurants or institutions.

Preparation in advance of a trade show is generally handled by interaction with the master server 10. Generally, at the ordering show, operations will be preformed in conjunction with a show server 20. In the alternative, remote connection to the master server 10 from the show could be provided. The master server 10 and show server 20 are illustrated as being interconnected. In the alternative, the show server 20 could be loaded from portable media 22 including data and programs copied from the master server 10. In a preferred form, a highly redundant operating environment is provided. In this regard, a redundancy unit 23 may be used that comprises a secondary web server and a secondary SQL server that are equal in capability to the master server 10. The redundancy unit 23 is coupled to back up the show server 20.

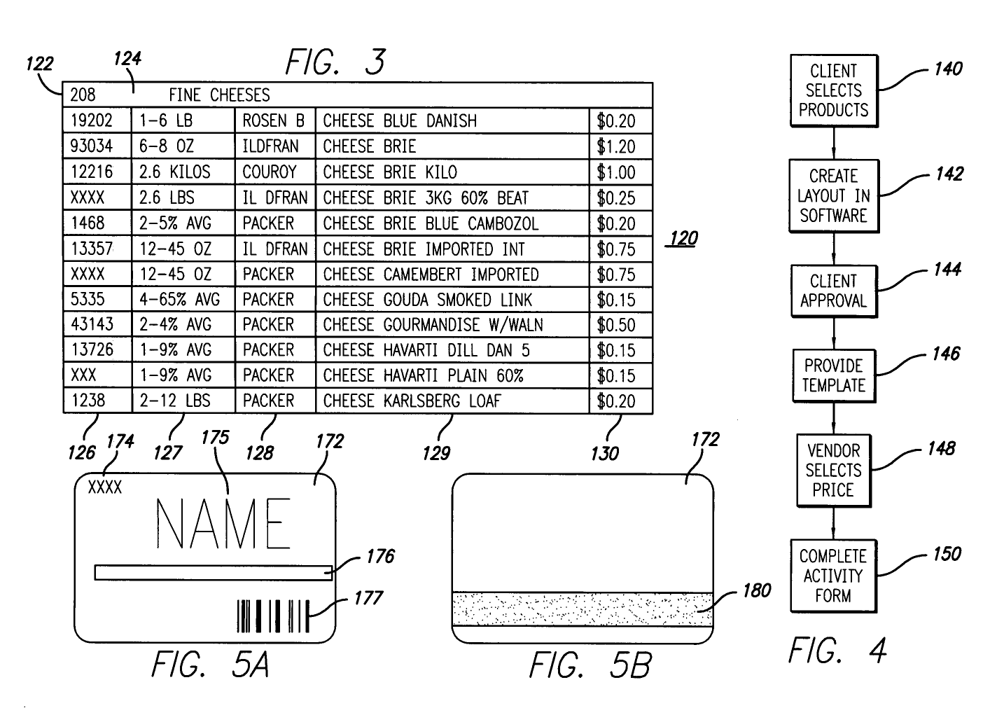

The client 14 will interact with the master server 10 through a client workstation 24. Exhibitors 16 and customers 18 will interact with the master server 10 through workstations 26 and 28 respectively. The workstations 24, 26 and 28 may interface with the master server 10 via the Internet 34. In the alternative, the workstations 24, 26, and 28 may interface with the master server 10 using any connection readily known to those of ordinary skill in the art. Similarly, the company workstation 12 may be coupled to the master server 10 via an Ethernet network 36. The workstation 12 could alternatively be coupled to the master server 10 via the Internet 34 or any other connection readily known to those of ordinary skill in the art. The client 14 and exhibitors 16 will interact with the master server 10 to produce ordering forms and a show “book” or catalog, as further explained with respect to FIGS. 3 and 4.

The customers 18 may preregister for the trade show via a registration module 40. The registration module may also be used to produce credentials for exhibitors 16 and sales representatives of the client 14.

At the trade show, the show server 20 may be connected to an Ethernet network 50 or any other type of network readily known to those of ordinary skill in the art to interact with other subsystems. A plurality of wireless access points 53 may be provided to eliminate the need for wiring between terminals (described below) and the Ethernet network 50. The wireless access points 53 provide communications by a wireless protocol, for example IEEE 802.11(b) or a more recent version thereof. The various revision levels of the IEEE wireless protocol are collectively referred to in the art as IEEE 802.11(x). While the 802.11(x) protocols have greater speed and range capability, ZigBee, Bluetooth or other wireless protocols could be used herein as well. Subsystems, which will be further described below, may communicate with the show server 20 via the wireless access points 53. The subsystems include a show registration cluster 60, a group 63 of point of sale (POS) ordering stations 64 which may each comprise an exhibitor booth staffed by exhibitor representatives 62, customer check in stations 65, customer stations 67, and a group 70 of sales representative stations used by sales representatives 68. Commonly, the sales representatives 68 will represent the client 14.

In the description of the remaining figures, frequent reference will be made to interactions of the company 8, client 14, exhibitors 16, customers 18, exhibitor representatives 62 and sales representatives 68 with a method, apparatus or medium being discussed. It should be remembered that these entities appear in FIG. 1, and may not appear in the illustration of the item with which they interact.

FIG. 2 is a block diagram illustrating the master server 10. The master server 10 is preferably an SQL (structured query language) server in which data is managed in a relational database. The master server 10 and apparatus interacting therewith can respond to commands of a machine-readable medium. A machine-readable medium includes any mechanism that provides (i.e., stores and/or transmits) information in a form readable by a machine (e.g., a computer). For example, a machine-readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.) etc. The architecture of the master server 10 may be embodied in a number of ways well known in the art to provide a described operation. For example, discrete databases are illustrated. However the various databases could comprise locations within a single memory unit. Communications interfaces such as the Internet 34 and an Ethernet network 36 connect to the master server 10 via a communications bus 80. Also connected to the communications bus 80 are a processor 84, a program memory 86, a data memory 88 and a plurality of databases, including without limitation a registration database 92, a product information database 94, a sales history database 96, a customer purchase database 98, and a lead capture database 100.

In this regard, a registration database 92 includes customer information such as names of individuals associated with a particular customer organization, address of the organization, and purchases made. The registration database may also include identity information for exhibitors and others to match identities with authorizations for particular tasks or entries.

A product information database 94 includes product information including s, quantity discounts available, show allowances, premiums available for quantity purchases, and incentive points available for making purchases or taking actions, for example. In a preferred form, the product information database 94 comprises activity forms, also known in the art as “deal sheets.” An activity form is generally an electronic or paper document, further discussed with respect to FIG. 3 below, that is associated with one exhibitor 16. The activity form allows a customer 18 to see product information and select available options. Available options include item selection and quantity selection.

A sales history database 96 includes historical data relating to past purchases made by customers 18. As further described below, historical data for a particular customer 18 may be used to generate advance booking orders in advance of the show opening for approval by the customer.

A customer purchase database 98 stores sales information generated during the show. This information can be used in several ways, as described below.

A lead capture database 100 can store information about various customers 18 for various exhibitors 16. The customers 18 need not necessarily be making purchases.

The present system provides significant advantages in data handling are provided before, during and after an ordering show. For example, prior to the ordering show, activity forms and show catalogs are produced. Customers 18 can be preregistered. Exhibitor representatives 62 and exhibitors 16 can have identity profiles stored along with sets of authorizations.

During the show, data on a wide variety of transactions is collected that is available in real time. For example, customers 18 may check their current levels of purchases. Additionally, sales representatives 68 may interact with customers 18 by examining their current purchase levels and offering them opportunities to avail themselves of further discounts or incentives. Further, the client 14 and exhibitors 16 have the capability to track the performance of individual exhibitor representatives 62 or sales representatives 68 or buying by particular customers 18 while the show is still in progress.

Further, at the close of a show, performance information of various sorts is readily available. For example, exhibitors 16 can review performance of particular products and do a wide variety of data processing. Efficacy of incentives can be measured. Order fulfillment data such as shipping information is available for transfer to servers operated by exhibitors 15. This allows the client 14 to evaluate the overall performance of the show.

Among various requirements, the preparations for staging an ordering show can include enabling the placing of orders. To make the necessary preparations, the client 14 can distribute items of many exhibitors 16. Generally, each exhibitor 16 will offer a range of products or services. The client 14 can elect to carry either a selection of offerings from the exhibitor 16 or the exhibitor's 16 full line. The selections are embodied in a medium presented to customers 18 which is referred to as an activity form. The primary type of activity contemplated in response to the offerings is sales of the offering, but other activities, e.g. provision of information, could be accommodated.

A nominal activity form 120 in this regard is illustrated in FIG. 3. The activity form 120 is preferably stored in electronic form in the product information database 94 in the master server 10. Authorizations such as passwords can be utilized so that each exhibitor 16 will be able to access only their own information from the product information database 94. In addition to activity forms 120, particular product information may also be stored in the product information database 94 so that an exhibitor representative 62 at a POS ordering station 64 may provide product information to a customer 18. Generation of the activity form is further described with respect to FIG. 4 below. A show book 122 is generated which comprises a compilation of all activity forms 120 for the show. The show book may also comprise advertisements and other information.

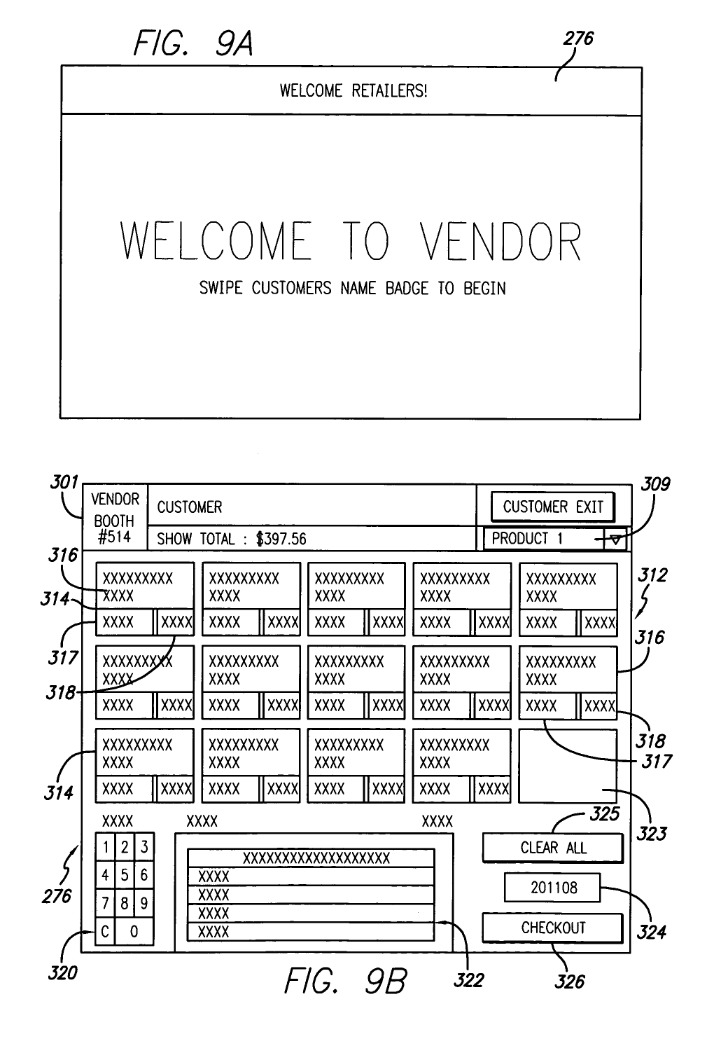

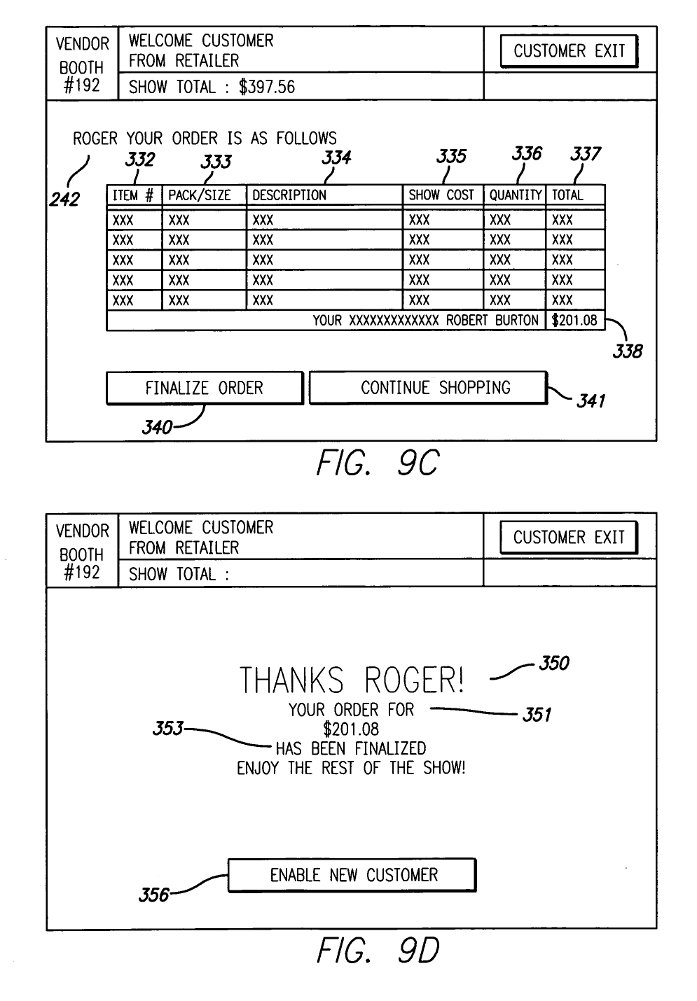

FIG. 3 illustrates the activity form 120, which is abbreviated in length for ease in illustration. A first field 122 is a numerical designation of the location of the booth 64 for a given exhibitor 16. A second field 124 is a name of the exhibitor 16. The particular activity form of FIG. 3 includes columns 126-130. Column 126 is a unique product identifier, such as a UPC (universal product code) identifier. The numerical form of the code is illustrated rather than a bar code. Column 127 describes the number of subunits within a package and the size of each subunit. Column 128 lists the brand name. Column 129 comprises a field describing the nature or name of the product. Column 130 lists a “show price,” which may reflect a discount provided to a customer 18 in order to encourage the customer 18 to make purchases at the trade show. The activity form 120 is the basis for the ordering screen display described below with respect to FIG. 9. The activity form 120 may be entered into the master server 10 even as late as the day of an ordering show. Therefore, if an exhibitor 16 has missed a deadline for providing advance written materials, it may still offer its items at the trade show.

Derivation of the activity form 120 is described with respect to FIG. 4, which is flow chart illustrating use of a form application. The client 14 deals with a wide variety of exhibitors 16. Each exhibitor 16 lists a wide variety of products it offers. At block 140, the client 14 selects which of the products of an exhibitor 16 the client 14 will offer to customers 18. The client 14 may provide inputs to the master server 10 via a workstation 24. The trade show company 8 (or any other party who might perform this function) can put this product information into an activity form template at block 142. At block 144, the trade show company 8 works with the client 14 to get approval for the activity form template. At block 146, the activity form template is provided to the exhibitor 16 with which it is associated. The exhibitor 16 sets its own prices, allowances and incentives. At block 148, the exhibitor provides pricing and allowance information. The exhibitor 16 may provide its inputs to the master server 10 via the workstation 26. At block 150, the trade show company 8 completes the activity form. In alternative embodiments of the present subject matter, the order of the above steps may be varied. For example, an exhibitor 16 could do a first draft of a list of products it will offer. Editing by the client 14 to indicate which products it decides to distribute can follow review of a list by the exhibitor 16 rather than precede it.

Another common preshow activity is preregistration. In a preregistration application, customers 18 register by interacting with the master server 10 and the registration module 40. Preregistration in advance of a show is optional, but is usually more convenient than registration at a show. Registration at the show is described with respect to FIG. 7 below. To preregister, customers 18 may each utilize a customer workstation 28 to contact the master server 10 and interact with a registration program housed in the program memory 86. Registration information regarding the particular customer 18 is stored in the registration database 90. Nominal registration information can include personal identity, affiliation, an address for correspondence, and an address for shipment of items that are ordered. A code for the customer 18 will correlate with a code identifying the same customer 18 in the sales history database 96 when the customer 18 has a sales history with the client 14. Similarly, exhibitor representatives 62 may contact the master server 10 via the workstation 26 for corresponding exhibitor 16. An authorized representative of the exhibitor 16 establishes a table of permissions for individuals. For example, as further described below, an individual can use a registration card at a POS terminal to open or close a POS station 64. The level of permission for an exhibitor representative 62 can be included in the registration information.

Prior to the show, personnel of the trade show company 8 may operate the registration module 40. The registration module 40 may include a hub 160 coupled to first and second workstations 162 and 164. In this regard, the first and second workstations 162 and 164 may respectively operate a card printer 166 and paper printer 168. An additional printer 170 may be connected to the hub 160. Many other suitable hardware arrangements will be apparent to those skilled in the art and are contemplated herein.

Accordingly, an employee at one of the workstations 162 or 164 may access registration information to print credentials further described with respect to FIG. 5 below. Employees may also enter registration information received through postal service or by fax to produce show credentials. Alternatively, an automated process for printing may be enabled.

FIG. 5 consists of FIG. 5a and FIG. 5b, which are respectively illustrations of the front and back of a credential comprising a card badge 172. The card badge 172 is normally carried in a card holder worn by an individual, and it can function as an identification badge. The card badge 172 can also function as a data card at various terminals. In a preferred embodiment, the card badge 172 includes several field identifiers, such as a field 174 identifying the event. The field 174 may include a logo for reinforcing brand identification of the client 14, field 175 can include the registrant's name, a field 176 may include useful sales information such as a customer account number and the name of a sales representative assigned to the particular customer 18, and a field 177 can be a unique identifier for the badge. In the particular embodiment of FIG. 5, the unique identifier is a bar code. Many other forms of unique identification that are readable by an identification reader could be used. Bar codes are conveniently usable. RFID (radio frequency identification) tags or other forms of identification could be used. Newer systems may employ a memory stick combined with a scanner and a USB port.

FIG. 5b illustrates the reverse side of the badge 172, which carries a magnetic stripe 180. The magnetic stripe 180 is useful in reading further identification information regarding the customer 18. The magnetic stripe 180 is also useful in that information regarding the customer 18 may be written onto the magnetic stripe in a well-known manner.

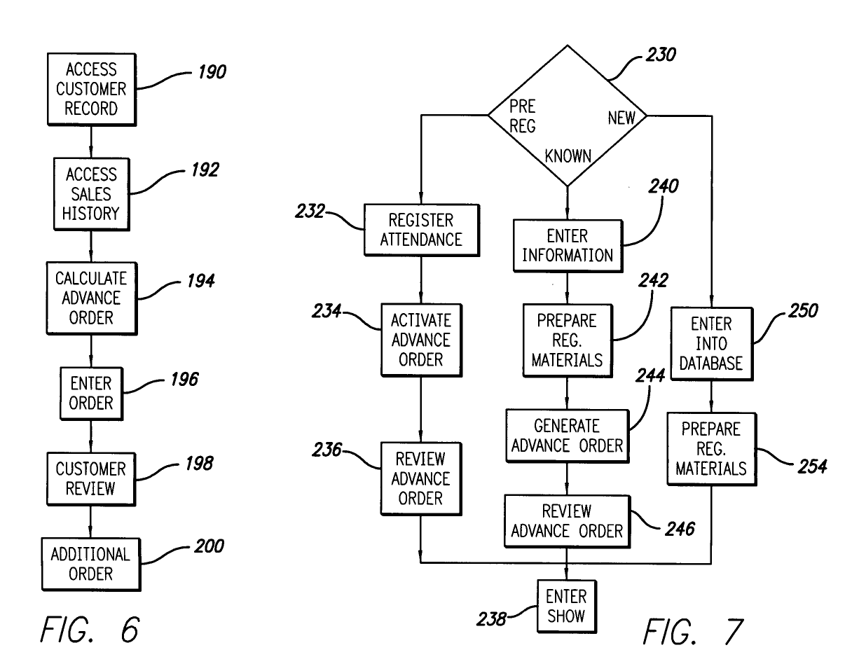

It is a common practice for customers 18 to advance booking orders for items they know they will want to buy through the ordering show. It is also a common practice for clients 14 to generate proposed advance booking orders for approval by customers 18. In conjunction with the preregistration process, the trade show company 8 may set up a customer purchase database 98 to accommodate advance booking orders. In this regard, advance booking orders are generated as illustrated by the flow diagram of FIG. 6.

The process of FIG. 6 can be accomplished by programmed media in the program memory 86 or by an operator at a workstation 162 or 164. At block 190, a customer record for a particular customer 18 can be accessed from the registration database 92. At block 192, the sales history database 96 can be searched and a record accessed if there is one. The sales history will preferably include past relevant sales information indicative of order levels the customer 18 will be expected to want to advance booking in advance of the ordering show. This historical information may, for example, comprise a record of the customer 18's purchases over a selected preceding time period or prior advance booking orders from previous ordering shows. An algorithm is utilized to establish advance booking levels based on the history, and a advance booking order is calculated, as indicated at block 194. Commonly known existing algorithms may be used in this regard.

At block 196, a advance booking order is entered in the customer purchase database 98. The customer 18 will review and finalize the advance booking order by accepting, rejecting or modifying the advance booking order at block 198. The customer 18 may be given access to the customer purchase database 98 via a workstation 28, or may be provided with the advance booking information at entry to the ordering show as discussed in connection with FIG. 7 below. Additionally, at block 200, the customer 18 is given access to advance booking further orders in addition to those generated by the above process. The order of these steps may be varied. For example, the operation at block 200 could occur elsewhere in the sequence described above and need not necessarily come last.

At a preselected time before the show, e.g. one day, preregistration can be closed. For example, access to the activity application and the preregistration application at the master server 10 by exhibitors 16 and customers 18 via the Internet 34 is closed. The system is then ready to operate to execute show functions.

At a show, and processes can be run on the master server 10 located remotely from the show. Preferably, to eliminate issues with respect to communication to a remote location, the show server 20 is utilized. Databases and programs may be loaded to storage media 22 for loading on the show server 20. Applications may be used in the same manner on the show server 20 as on the master server 10.

At the ordering show, registration can be handled at the show registration cluster 60. The show registration cluster 60 can have a hub 220 wirelessly linked to one of the wireless connection points 53. The hub 220 can connect to workstations 222 and 224 which can operate printers 226 and 228, respectively. The workstations 222 and 224 can be operated by the trade show company 8 personnel to enter registration information at the ordering show. Credentials such as that illustrated in FIG. 5 above may be generated by the printer 226 or 228. The at-show registration process can be illustrated according to the flow chart of FIG. 7. The at-show registration process includes registering attendees who have not preregistered, and also includes checking in of attendees who have preregistered.

In FIG. 7, at block 230, a decision is made whether a customer 18 reaching a controlled admission point at the show is preregistered, unregistered but in customer records, or is a new person with respect to the show system. Preregistered customers 18 are directed to the customer check in station 65 where they can swipe a card badge 172. Their attendance at the show is registered at block 232. Next the customer's 18 advance booking order may be accessed and displayed, as seen at block 234. The customer 18 may then approve the order so that the advance booking order is entered or may modify and enter the order, as indicated at block 236. The customer 18 then enters the show, at block 238. If the customer 18 is not preregistered, at block 240, customer identity is entered and if a customer record is present, it is accessed. Registration materials are prepared including a card badge 172, as indicated at block 242. A advance booking order may be generated, as indicated at block 244, and reviewed by the customer 18 who approves or modifies the advance booking order, as indicated at block 246. The customer 18 is then ready to enter the show, as indicated at block 238. For a customer 18 new to the system, information is gathered and entered at block 250. Registration materials are generated at block 252 and the customer 18 may enter the show, as indicated at block 238.

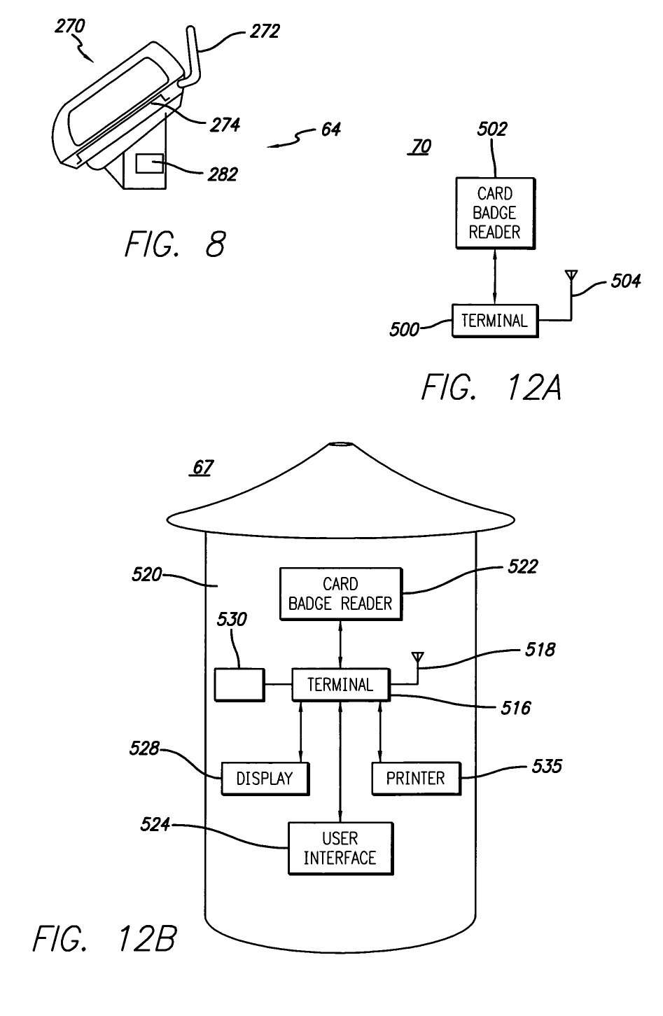

FIG. 8 is a block diagrammatic form of a POS ordering station 64. Each POS ordering station 64 includes at least one POS terminal 270. Each POS terminal 270 may be provided with a wireless link 272 to wireless connection points 53. An identification apparatus can be provided in the form of a card badge reader 274 coupled to the POS terminal 270. In this particular embodiment, the card badge reader 274 comprises a magnetic stripe reader. Other forms of reader known to those of ordinary skill in the art could be provided. A customer 18 swipes a card badge 172 in order to initiate a customer session. An exhibitor 16 given authority in the preregistration application described above can swipe a card badge 172 to enable an administration routine. The exhibitor 16 can perform such functions as enabling the system to transact business or locking the POS terminal 270 when leaving the POS ordering area 63.

The POS terminals 270 can each include a display 276 with which the customer 18 may interact. Preferably, the display 276 comprises a touch screen display. Alternatively, the POS terminals 270 could use a keyboard or other input device. However, the activity form 120 (FIG. 3) and the software which creates the screens of FIG. 9 below are set up to allow complete, convenient entry of order information through the use of a touch screen. The POS terminal 270 includes a register 282 for storing selections made by the customer 18. Other well-known means for registering a selection may be used. At the completion of an ordering routine, the stored data may be transmitted from the register 282 to the show server 20.

FIG. 9 consists of FIGS. 9a-9d, each of which illustrates a screen on the display 276 of POS terminal 270 in FIG. 7. As seen in FIG. 9a, the display 276 may carry a steady-state message welcoming customers to the exhibitor 16's booth. Alternatively, the display 276 may run a video presentation stored in a portion of the show server 20 dedicated to the particular exhibitor 16 promoting its products. A customer 18 runs his card badge through the card badge reader 274. This initiates the display of a buying screen as shown in FIG. 9b. The descriptions of the fields in FIG. 9 can also describe the source code used to produce the displayed fields. Known functions can be used to generate the routines selected for performance. The spatial relationships of the various fields described below can be varied without affecting operability.

At the top of the display 276, a first field 301 identifies the exhibitor 16 and location of the booth 64. Next, field 302 may contain a welcoming message and displays information read from the card badge 172 including the name of the customer 18 and the organization represented by the customer 18. Field 303 is a touch screen button to allowing the customer 18 to exit from the display. Below field 306 is a field 308 comprising a drop-down menu 309. The drop-down menu 309 is operable by the customer 18 when pressed to offer a menu displaying a plurality of pages. The exhibitor 16 may arrange the pages by type of goods, different brand names carried by the exhibitor 16, or subcategories within goods. The drop-down menu 309 permits the customer 18 to select a particular page.

An ordering matrix 312 is preferably disposed at the center of the screen. The ordering matrix 312 can include a plurality of boxes 314, each comprising a touch screen button. Each box 314 can be associated with one product. A customer 18 can select one of the boxes 314 associated with a product of interest. The box 314 may change color or otherwise indicate its selection when pressed. In FIG. 9b, the selected box 314 has a bold border. Within this box 314, a field 316 identifies a product, a field 317 includes a price, and a field 318 displays a selected quantity. A touch screen keypad 320 can be provided through which a customer 18 may select a quantity to enter in a field 318 or clear a quantity entered in a field 318. To order, a customer 18 can select a box 314 to highlight the box. Then the customer utilizes the keypad 320 to select a quantity of units to order. Alternatively, the customer 18 may authorize the exhibitor 16 to make entries on behalf of the customer 18.

A field 321 may display earned incentive points. A field 322 may display order information for the particular customer 18 associated with other exhibitors 16. Alternatively, the field 322 may display sales history of the customer 18 with the current exhibitor 16 or both. Pressing the box 314 may also invoke display of a field 323 which includes advance booking information. The field 323 may include rows in which a first column displays quantity and a second column displays a selected delivery date. This information can be accessed from the order database 86. A field 324 displays a running total of the order within the current exhibitor 16. Touch screen buttons 325 and 326 are provided respectively for the clear function and for checkout. When the customer 18 or other authorized person depresses touch screen button 326, operation proceeds to FIG. 9c.

FIG. 9c represents a recap screen including a grid 330 summarizing the current order. In a column 332, item numbers are displayed. Column 333 displays the units of an item or quantity contained in the item. Column 334 displays the unit description. Columns 335, 336, and 337, respectively, show the unit price, quantity ordered, and total price. Box 338 shows the total of the order. The customer 18 may press a touch screen button 340 to finalize the order or press a touch screen button to 341 to continue shopping. A field 342 may be provided to display the customer 18's name and state that this is an order recap, further enhancing the experience of interactivity. When the order is finalized, operation proceeds to the screen of FIG. 9d. A field 350 contains a fixed message such as an expression of thanks along with a personalized portion such as the name of the customer 18. A field 351 repeats the total of the order. A field 352 confirms finalization of the order, and a field 353 provides a closing message, for example, “Enjoy the rest of the show!” The POS terminal 270 may be reset to enable response to a next customer 18 by depressing a touch screen button 356, by timeout of a timing circuit, or by other known means.

FIG. 10 is a flow diagram illustrating a preferred method performed by the system with respect to ordering as illustrated with respect to FIG. 9. Steps listed in FIG. 10 need not necessarily take place in the order illustrated, unless they would lead to a logical contradiction. For example, the show server 20 could enable display of a screen with field displaying items on sale prior to producing a display indicative of the identity of a customer 18. However, the identity of a customer 18 would not be displayed prior to reading a medium such as the card badge 172 containing the customer's 18 identity.

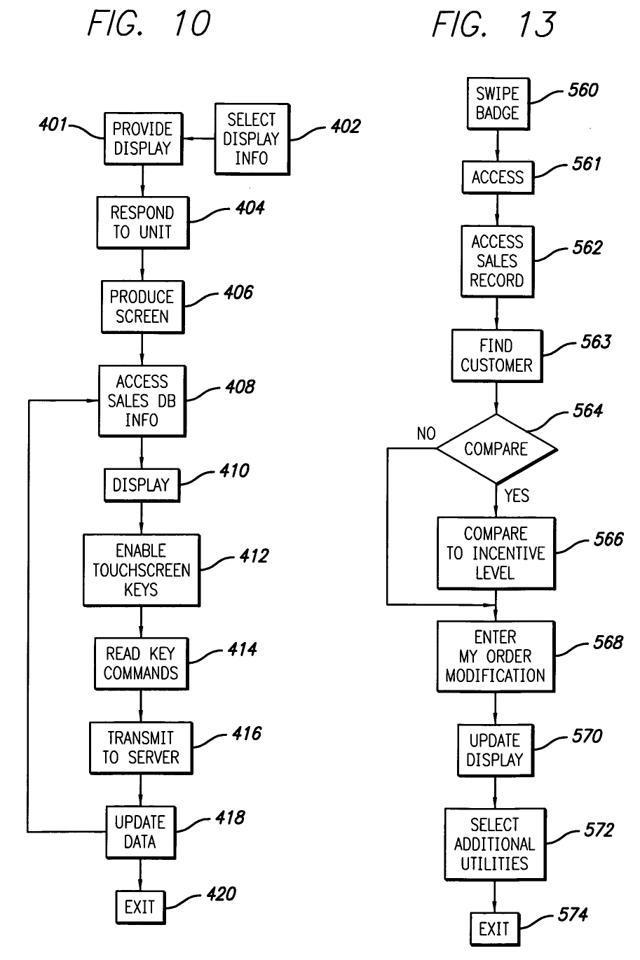

At block 401, display information can be provided to the POS terminal 270. The display preferably comprises memory data from the show server 20. Display information could also be provided locally. The display could comprise the greeting screen of FIG. 9a. Alternatively, when the POS terminal 270 is not taking orders, the screen 276 could be used to show promotional video presentations stored in the product information database 94 or locally. A block 402 is shown providing input to the block 401 for selecting display information in order to select the memory location or locations supplying data to the POS terminal 270. This election could be based on a timer or may be condition responsive. Another alternative is selection by an administrative function performed by an exhibitor representative 62. This form of administrative function is further discussed with respect to FIG. 11 below.

In order to initiate a sales routine, a customer 18 can produce an input signal by running a card badge 172 through the card badge reader 274. At block 404, the system can respond to the input signal. Alternatively, an exhibitor 16 may run an exhibitor badge through the card reader 274 to initiate an administrative routine. At block 406, a responsive screen can be produced on the display 276. In the case of a customer 18 input, the screen of FIG. 9b is produced. At block 408, the show server 20 can provide program display information. As illustrated in FIG. 9b, program display information includes customer 18 identity and field 302, the show total in field 306, and exhibitor purchases in the field 322. Then at block 410, this information is displayed. Touch screen keys for the given display are enabled at block 412. At block 414, commands are read in response to selection of touch screen keys. At block 416, updated information is transmitted to the show server 20, and at block 418 appropriate registers or database memory locations are updated. The block 418 is shown providing input to the block 408 to illustrate that the display 276 of the POS terminal 270 is updated to display current information. A local computer in the POS terminal 270 could be provided to process the update. However, it is preferable in terms of cost and efficiency to provide centralized data processing at the show server 20. In order to complete the routine, a touch screen button such as the button 356 in FIG. 9d may be pressed to exit the routine at block 420.

The method of FIG. 10 may also be used to educate customers as to the products of exhibitors 16 available. For example, instead of having the customer 18 operate the screen of FIG. 9b to order products, an exhibitor 16 may operate the screen to invoke a display of information to a customer 18. When the customer 18 has been “educated” as to particular items, the exhibitor can enter an input in the nature of entering an order. However, rather than having an order entered, the customer 18 is credited with having received the information. A preselected value of credit, e.g., a selected number of incentive points, is registered for the customer 18 in a manner similar to registering of purchases.

FIG. 11 illustrates a utility screen that can be displayed on the POS terminal 270 for use by an exhibitor representative 62. Touch screen buttons 461 through 466 are provided to provide a group of commands which may be referred to as exhibitor utilities. In this specific example, the button 461 invokes a command to begin taking orders, thus enabling production of the screens illustrated in FIG. 9. Button 462 invokes a utility to show orders received. This button may produce a screen including a touch screen keyboard so that an exhibitor 16 may select particular reports. Button 463 invokes a product performance report command. Again, a screen user interface such as a keyboard may be provided so that a user can access sales reports by product number, name, category or other desired indexing feature. Box 464 may be used to connect to show directory information in order to find the booth of another exhibitor. Box 465 may be used to invoke a routine to initiate a call on behalf of the exhibitor 16 to technical support personnel. Box 466 is selected to invoke a menu of other exhibitor utilities, which may be provided in a known manner.

FIG. 12 consists of FIGS. 12a and 12b, which are block diagrams respectively of a sales representative station and a customer station. FIG. 12a is a more detailed view of the sales representative station 70 of FIG. 1. The sales representative station 70 comprises a terminal 500 in order to access the show server 20 for wide variety of applications. The terminal 500 includes a card badge reader 502, either integrally or as a peripheral device. The terminal 500 may also include a communications link 504 so that sales representatives 68 may communicate with one another by voice or data. The terminal 500 also has a wireless link to communicate with wireless access points 53. The terminal 500 could comprise a tablet computer or a personal electronic device that may combine telephone and computer capabilities. Sales representatives 68 each have responsibility for sales of a set of products or services to a portfolio of customers 18. The sales representative 68 can use a card badge 172 to gain access to a list of customers he or she represents. The show server 20 is programmed to provide to the sales representative 68 the option to access customer data housed on various databases. The sales representative 68 can determine which of his or her customers 18 have or have not attended the show, which customers 18 are currently present and where they did their last transactions. Sales data reflecting orders entered by each customer 18 can also be obtained. This data can be used in various ways.

Accordingly, the sales representative 68 is enabled to go and find each customer 18. The sales representative 68 can discuss with a customer 18 why advance booking orders or show orders might be below historical levels. The sales representative 68 can suggest complementary sales. The sales representative 68 can also point out additional discounts and premiums that they customer 18 may gain with further incremental purchases. The terminal 500 is enabled to respond to card badges 172 of customers 18 so that further orders can be entered. The sales representative 68 may both increase the sales volume for the exhibitors 16 and increase the value provided per dollar to the customer 18. To provide a further reason to have a customer 18 visit the sales representative station 70, the sales representative terminals 500 may be further enabled to allow customers 18 to check in as an alternative to checking in at a check-in terminal 65.

FIG. 12b illustrates the customer station 67 of FIG. 1. The customer station 67 is intended to serve as a customer service station and as a location for a customer to check out of the show. The client 14 and exhibitors 16 will find it useful to know whether or not a customer 18 is present. The registration database 92, for example, could contain a routine in which the customer 18 checks out before leaving the show. An incentive such as show points awarded in response to performance of a checkout routine could be provided to encourage a customer 18 to be sure to take the time and effort to checkout prior to leaving the show. The checkout routine can also provide the customer 18 with printouts and computer files of all transactions by the customer 18 at the show.

The customer station 67 can comprise a customer terminal 516, and may take any of a wide variety of physical forms. The customer terminal 516 may connect with the show server 20 via wireless access points 53 via a wireless link 518. A kiosk 520 may be used as a housing for this embodiment since it has a wide customer appeal, is readily visible at a trade show from a distance, and provides physical facilities for display of graphics and incorporation of further utilities. The customer station 67 may comprise any number of forms of computer devices capable of interrogating the show server 20 and providing outputs to a customer 18. The terminal 516 may further include a card badge reader 522, a user interface 524, a printer 536, a display 528 and a communications link 530. The communications link may provide the customer 18 with Internet access or other forms of communication. The user interface 524 may comprise a keyboard, touch screen incorporated in the display 528, a computer mouse, or all of above. A customer 18 may at various times use the customer station 67 to review orders placed, review show directory information which may be housed in the show server 20, use email, and produce printed reports.

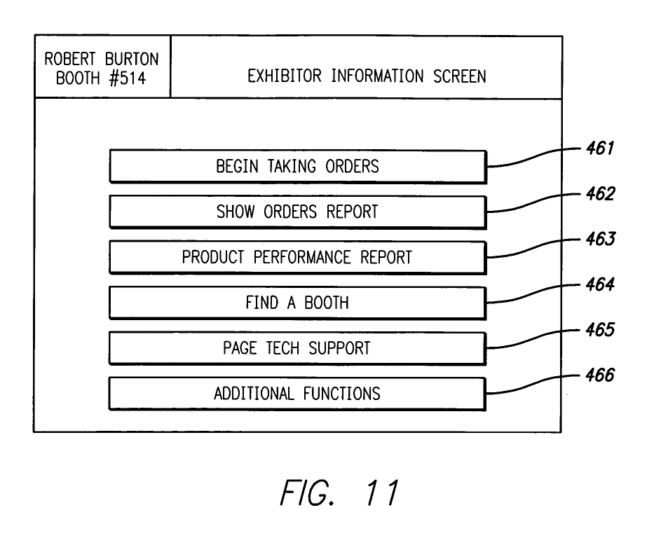

FIG. 13 is a flow diagram illustrating querying of the system by a sales representative 68, for example at a sales representative 68 terminal 40. At block 560, the sales representative 68 can gain access to the system by swiping a card badge 172 in the card badge reader 502. At block 561, the sales representative can enter customer information, and the show server 20 can determine the most recently logged location of the selected customer 18. The sales information associated with the customer 18 can be accessed at block 562 and displayed at the sales representative terminal 500. Overall sales data can be reviewed. Additionally, individual pages of orders for the customer 18 may be accessed in the same manner that individual pages are accessed by use of field 209 in FIG. 9b, i.e., with a drop-down menu.

The sales representative 68 finds the customer 18, as indicated at block 563 to review current orders with him or her. At block 564, a decision is made whether or not to compare the purchase levels by the customer 18 to levels necessary to achieve particular discounts or other incentives for each product or to compare order levels to historical order levels. If selected, the comparison is performed at block 566. The comparison may be made manually by the sales representative 68. Alternatively, an automatic comparison may be invoked by selection of a particular product number or a command to compare to the entire order history.

If the comparison is not made, or after the comparison, the operation proceeds to block 568. Update information in response to feedback elicited by the sales representative 68 from the customer 18 is entered in order to update the customer order. At block 570, the ordering information for the customer 18 is displayed. Additional savings gained by the customer 18 may also be displayed. Additional utilities may be selected at block 572. For example, the sales representative 68 may produce printouts or other reports for the customer 18. At block 574, the process is completed.

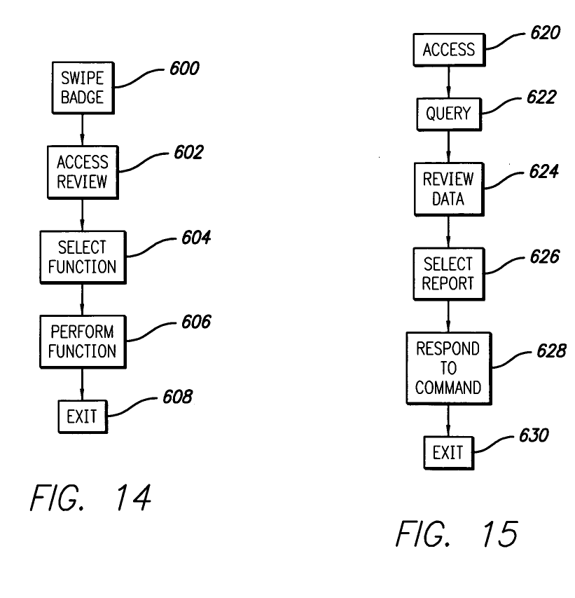

FIG. 14 is a flow diagram illustrating querying of the system at the customer station 67. At block 600, the customer 18 swipes card badge 172. Information associated with the customer 18 is accessed as shown at the customer terminal 516 at block 602. At block 604, the customer 18 selects a particular function and performs the function at block 606. The functions in the preferred form include selecting the printer and printing, producing selected reports for display, and selecting email. Another function is customer checkout. After performing a function other than checkout at block 606, the customer 18 may return to block 604 to select another function. Additional functions may be provided. When the customer 18 completes performance of the desired functions, the customer 18 may select a command to clear the customer terminal 516 and exit the process at block 608. The customer 18 may visit the customer terminal 516 at the kiosk 520 as many times as desired to keep track of activity.

FIG. 15 is a flow diagram illustrating production of show information. At block 620, a client 14 or exhibitor 16 inputs a password to access the show server 20. The password determines a selected group of databases or memories or memory locations to which access is provided. At block 622, the particular databases are selected and queried. Data is reviewed at block 624. The option to input annotation information and report selection and additional information is provided at block 626. At block 628, commands are responded to in order to produce reports displays or other output information. At block 630, the process is exited.

As explained above, many variations can be provided in the particular embodiments disclosed to provide a method, system, and machine-readable medium in accordance with the present subject matter. The present subject matter being thus described, it will be apparent that the same may be varied in many ways. Such variations are not to be regarded as a departure from the spirit and scope of the present subject matter, and all such modifications are intended to be within the scope of the appended claims.

1. A system for handling tradeshow information comprising:
a server comprising a product information database comprising entries indicative of preselected product offerings available for selection for a customer, each product offering being associated with an exhibitor;
an exhibitor terminal accessing product offerings associated with the respective exhibitor from said product information database, said exhibitor terminal being coupled to communicate with said server;
a customer purchase database for storing selections made by a customer, said selections being sortable by exhibitor;
an identification reader at said exhibitor terminal responsive to a customer input to identify the customer; and
order entry means at said exhibitor terminal, said order entry means being operable to receive said customer input and to register selections made by said customer and store data indicative of said selections in said customer purchase database in association with the identified customer.

2. The system according to claim 1, wherein said exhibitor terminal comprises a display to display selected product offerings.

3. The system according to claim 2, wherein said display comprises a touch screen display.

4. The system according to claim 3, wherein said product information database provides a purchase display indicative of an ordering matrix comprising a plurality of selections, each selection being associated with one product, and each selection comprising an area on said purchase display comprising a touch screen button for selecting said one product for ordering said one product.

5. The system according to claim 4, wherein said exhibitor terminal further comprises entry means for entering a quantity for said selected one product and wherein said entry means comprises a touch screen keypad on said touch screen display.

6. The system according to claim 5, wherein said purchase display comprises an ordering matrix and wherein said product information database stores a plurality of ordering matrices for selective display.

7. The system according to claim 6, wherein said purchase display comprises means for transmitting an order to a sales database.

8. The system according to claim 7, further comprising a customer terminal accessible to a customer to open a previously completed order and to update the order.

9. The system of claim 8, wherein said customer terminal is enabled for access by an identification reader.

10. The system according to claim 9, wherein said customer terminal further comprises utilities selected from the group consisting of a printer, a display, a user interface, a communications link, and combinations thereof.

11. The system according to claim 7, further comprising a sales representative terminal for accessing customer records enabled for access by a sales representative.

12. The system according to claim 11, wherein said sales representative terminal comprises a portable terminal device.

13. The system according to claim 6, wherein sales records are collected by a client and further comprising order means for providing order information to exhibitors sorted by customer.

14. A method for processing tradeshow information comprising:
establishing an activity form indicative of groups of product offerings, each product offering comprising a product description and a price, each group being associated with an exhibitor;
providing a group at an exhibitor terminal;
enabling offering of the group to a logged in customer in response to a customer login at a customer terminal;
establishing a customer purchase register to store sales selections by customer in association with each exhibitor; and
providing to said exhibitors ordering data associated with each respective exhibitor from said customer purchase register.

15. The method according to claim 14, further comprising providing information at said exhibitor terminal indicative of the purchases from all exhibitors by the logged in customer.

16. The method according to claim 15, further comprising providing access to a product offering to a sales representative in conjunction with a login for a customer whereby the sales representative is enabled to order selections in response to authorization by the customer.

17. The method according to claim 16, further comprising comparing a record of purchases for an exhibitor by the logged in customer to a list of incentive threshold levels for selected products to provide a report indicative of further purchases that can be authorized by the logged in customer to gain incentives.

18. The method according to claim 17, further comprising providing a customer terminal to said logged in customer and enabling said customer to select, review and/or modify sales records.

19. The method according to claim 18, further comprising providing selectable utilities to the logged in customer selected from the group consisting of a printer, a display, a communications line, a user interface, and combinations thereof.

20. The method according to claim 14, further comprising establishing a registration database, creating a unique identity for each of a plurality of registered customers and providing a credential for use by a registered customer to log in.

21. A machine readable medium that provides instructions, which when executed by processor, cause said processor to perform operations comprising:
establishing an activity form register indicative of groups of offerings, each offering comprising a description and a price, each group being associated with an exhibitor;
providing access to at least one said group at an exhibitor terminal;
enabling offering of the group to a logged in customer in response to a customer login at a customer terminal;
establishing a customer purchase register to store sales selections by customer in association with each exhibitor; and
providing to each said exhibitor ordering data associated with each customer of said respective exhibitor from said customer purchase register.

22. The machine readable medium according to claim 21, wherein the machine readable medium provides instructions to respond to customer login at the exhibitor terminal.

23. The machine readable medium according to claim 22, further comprising providing instructions to provide information at said exhibitor terminal indicative of the purchases from all exhibitors by the logged in customer.

24. The machine readable medium according to claim 23, further providing instructions to provide access to a product offering to a sales representative in conjunction with a login for a customer whereby the sales representative is enabled to order selections in response to authorization by the customer.

25. The machine readable medium according to claim 24, further comprising comparing a record of purchases for an exhibitor by the logged in customer to a list of incentive threshold levels for selected products to provide a report indicative of further purchases that can be authorized by the logged in customer to gain incentives.

26. The machine readable medium according to claim 25, further comprising providing instructions enabling the customer terminal to respond to selections by the logged in customer enabling said logged in customer to select, review and/or modify sales records from a sales database.

27. The machine readable medium according to claim 26, further comprising providing instructions to operate selectable utilities selected from the group consisting of a printer, a display, a communications line, a user interface, and combinations thereof.

28. The machine readable medium according to claim 21, further comprising a registration database, and providing instructions creating a unique identity for each of a plurality of registered customers and providing an input to an apparatus producing a card badge credential.

29. The machine readable medium according to claim 28, wherein said instructions provide a purchase display indicative of an ordering matrix comprising a plurality of selections, each selection being associated with one product and each selection comprising an area on said purchase display comprising a touch screen button for selecting said one product for ordering said one product.

30. The machine readable method according to claim 29, wherein said exhibitor terminal further comprises entry means for entering a quantity for said selected one product.
